(19) United States
(12) Patent Application Publication
(10) Pub. No.: US 2014/0171169 A1
(43) Pub. Date: Jun. 19, 2014

(54) APPARATUS, SYSTEM, AND METHOD FOR ELECTRONIC CONVENTION CARD

(71) Applicant: Robert Hampton, Henderson, NV (US)

(72) Inventor: Robert Hampton, Henderson, NV (US)

(21) Appl. No.: 14/135,268

(22) Filed: Dec. 19, 2013

Related U.S. Application Data
(60) Provisional application No. 61/739,634, filed on Dec. 19, 2012.

(51) Int. Cl. G07F 17/32

(52) U.S. Cl. CPC G07F 17/3293
USPC 463/11

(57) ABSTRACT

An apparatus, system, and method are disclosed for an electronic convention card that includes a convention presentation module that presents a list of predefined conventions to a player. The list of predefined conventions is presented to the player on an electronic display of an electronic device. The predefined conventions include bidding and playing conventions associated with a bridge card game. A convention selection module receives one or more convention selections from a player. Each selected convention is from the list of predefined conventions. The player inputs the selected conventions into the electronic device. A convention storage module stores the selected conventions on a computer readable storage media. The selected conventions are stored with an identifier associated with the player. A convention display module displays the selected conventions on the electronic display in response to a request by the player to display the conventions.

### CROSS-REFERENCES TO RELATED APPLICATIONS

This application claims the benefit of U.S. Provisional Patent Application Ser. No. 61/739,634 entitled “APPARATUS, SYSTEM, AND METHOD FOR ELECTRONIC CONVENTION CARD” and filed on Dec. 19, 2012, for Robert Hampton, which is incorporated herein by reference.

### FIELD OF THE INVENTION

This invention relates to the game of bridge and more particularly relates to using an electronic convention card during a bridge game.

### BACKGROUND

In general, bridge is a trick-taking card game that uses a standard deck of playing cards. It is usually played by four players in two competing partnerships. A game may consist of four phases: dealing the cards, bidding, playing the hand, and scoring the results. In order to bid, a bidding system may be established between partners in a partnership. The bidding system is a set of partnership agreements on the meanings of different bids and may include different bidding conventions pre-chosen by the partners that describe how to handle specific bidding situations. Bidding conventions are generally written down on a convention card, which is made available to all players in the bridge game. However, it may be tedious and wasteful to fill-out new convention cards when multiple games are being played, such as in a large bridge tournament.

### SUMMARY

The subject matter of the present application has been developed in response to the present state of the art, and in particular, in response to the problems and needs of using convention cards that have not yet been fully solved by currently available systems. In general, the subject matter of the present application has been developed to provide a system that uses electronic convention cards that overcome at least some of the above-discussed shortcomings of the prior art.

An apparatus for an electronic convention card is disclosed. A system and method also perform the functions of the apparatus. In one embodiment, an apparatus is disclosed that includes a convention presentation module that presents a list of predefined conventions to a player. In some embodiments, the list of predefined conventions are presented to the player on an electronic display of an electronic device. In another embodiment, the predefined conventions include bidding and playing conventions associated with a bridge card game.

The apparatus, in one embodiment, further includes a convention selection module that receives one or more convention selections from a player. In certain embodiments, each selected convention is selected from the list of predefined conventions and the player inputs the selected conventions to the electronic device. In another embodiment, the apparatus includes a convention storage module that stores the selected conventions on a computer readable storage media. In some embodiments, the selected conventions are stored with an identifier associated with the player. In yet another embodiment, the apparatus includes a convention display module that displays the selected conventions on the electronic display in response to a request by the player to display the conventions.

In one embodiment, the convention display module displays, along with the selected conventions, an identifier associated with the player and an identifier of a teammate of the player. The apparatus, in a further embodiment, includes a notes module that receives, stores, and displays notes entered by the player. In another embodiment, the apparatus includes a score module that stores a score of a bridge game of the player, which may be either calculated by the electronic convention card or inputted by the player. In certain embodiments, the apparatus further includes a security module that disables communication capabilities of the electronic device in response to receiving a command to enter a game play mode.

In some embodiments, the security module further re-enables communication capabilities of the electronic device and wherein the security module disables and re-enables communication capabilities of the electronic device by way of a security protocol, which may include a password and/or a security key. In another embodiment, the security module one or more of disables one or more applications running on the electronic device and disables access to the one or more applications running on the electronic device. In yet another embodiment, the security module further comprises a secured communication module that enables communication with a secured server. In some embodiments, scores are communicated to the secured server and the secured server is controlled by officials of a bridge tournament. In another embodiment, the secured communication module restricts communication to a one-way communication to the secured server.

In one embodiment, the convention storage module stores the selected conventions along with an identifier associated with the player. In a further embodiment, the apparatus includes a sharing module that shares, with an electronic device of another player, one or more of selected conventions of a player, a bridge score, and notes. In some embodiments, the sharing module further comprises a sharing authorization module that enables the sharing module to share selected conventions, scores, and notes with authorized electronic devices and disables sharing of the selected conventions, scores, and notes of unauthorized electronic devices. In certain embodiments, the sharing authorization module is accessed using a password.

A method for an electronic convention card is also disclosed. In one embodiment, the method includes presenting a list of predefined conventions to a player. In some embodiments, the list of predefined conventions are presented to the player on an electronic display of an electronic device. In another embodiment, the predefined conventions include bidding and playing conventions associated with a bridge card game. In one embodiment, the method includes receiving one or more convention selections from a player. In certain embodiments, each selected convention is selected from the list of predefined conventions and the player inputs the selected conventions to the electronic device.

In yet another embodiment, the method includes storing the selected conventions on a computer readable storage media. In some embodiments, the selected conventions are stored with an identifier associated with the player. In one embodiment, the method includes displaying the selected conventions on the electronic display in response to a request by the player to display the conventions. In some embodiments, the convention display module displays, along with the selected conventions, an identifier associated with the player and an identifier of a teammate of the player.

The method, in another embodiment, includes storing a score of a bridge game of the player, the score being one or more of calculated and inputted by the player. In a further embodiment, the method includes disabling communication capabilities of the electronic device in response to receiving a command to enter a game play mode. In one embodiment, the method also includes disabling one or more applications running on the electronic device and disables access to the one or more applications running on the electronic device. In yet another embodiment, the method includes enabling communication with a secured server. In some embodiments, scores are communicated to the secured server, which may be controlled by officials of a bridge tournament. The method, in another embodiment, includes sharing, with an electronic device of another player, one or more of selected conventions of a player, a bridge score, and notes.

A system for an electronic convention card is also provided. In one embodiment, the system includes an electronic device comprising an electronic display. In another embodiment, the system includes a convention presentation module that presents a list of predefined conventions to a player. In some embodiments, the list of predefined conventions are presented to the player on an electronic display of an electronic device. In another embodiment, the predefined conventions include bidding and playing conventions associated with a bridge card game.

The system, in one embodiment, further includes a convention selection module that receives one or more convention selections from a player. In certain embodiments, each selected convention is selected from the list of predefined conventions and the player inputs the selected conventions to the electronic device. In another embodiment, the system includes a convention storage module that stores the selected conventions on a computer readable storage media. In some embodiments, the selected conventions are stored with an identifier associated with the player. In yet another embodiment, the system includes a convention display module that displays the selected conventions on the electronic display in response to a request by the player to display the conventions.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of an electronic convention card system in accordance with the present invention;

FIG. 2 is a schematic block diagram illustrating one embodiment of a bridge apparatus in accordance with the present invention;

FIG. 3 is a schematic block diagram illustrating another embodiment of a bridge apparatus in accordance with the present invention;

FIG. 4 is a flow chart diagram illustrating one embodiment of a bridge apparatus in accordance with the present invention;

FIG. 5 depicts one example of a convention presentation module visually presenting a list of predefined conventions on an electronic display of an electronic device;

FIG. 6 depicts one example of a scoring table, which may be displayed on the electronic display of the electronic device by selecting the scoring tab; and

FIG. 7 depicts one example of an interface for entering and displaying notes created by the notes module.

### DETAILED DESCRIPTION

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireline, optical fiber, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

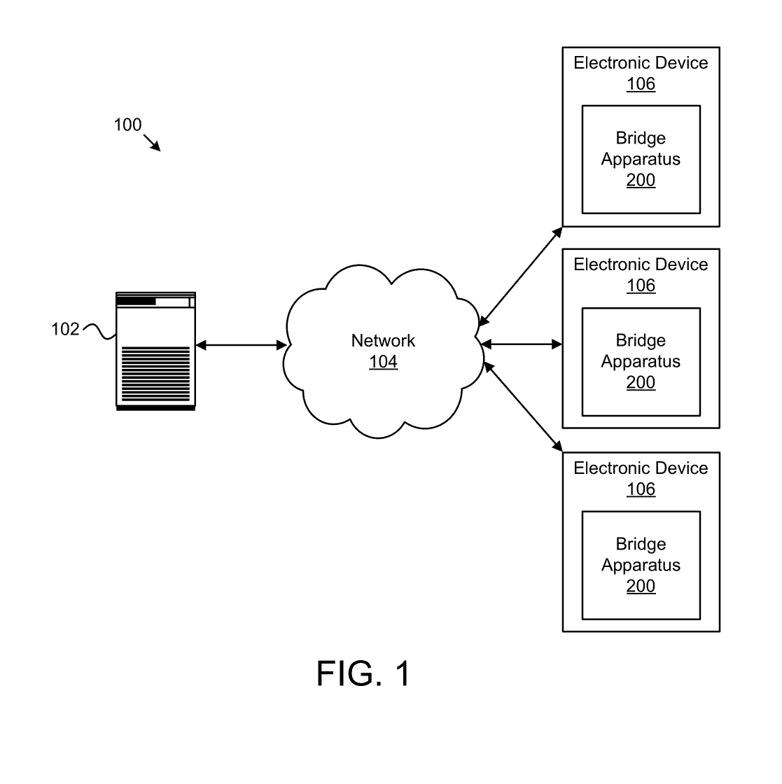

FIG. 1 is a schematic block diagram illustrating one embodiment of a system 100 for an electronic convention card. In the depicted embodiment, the system 100 includes a server 102, a network 104, and a plurality of electronic devices 106. In one embodiment, the electronic devices 106 may also be embodied as client devices. As used herein, the server 102 may be configured as a mainframe computer, a blade center comprising multiple blades, a desktop computer, a laptop computer, and the like. Although for simplicity one server 102, one network 104, and three clients 106 are shown, any number of servers 102, networks 104, and clients 106 may be employed.

The server 102, in one embodiment, may include computer readable storage media storing executable code and may include a processor that executes the executable code as is well known to those skilled in the art. The executable code may be tangibly stored in computer readable storage media in communication with the server 102. The server 102 may store data regarding a bridge game and/or tournament, in particular convention card and scoring data, which may be accessed and/or downloaded over the network 104 by the plurality of clients 106.

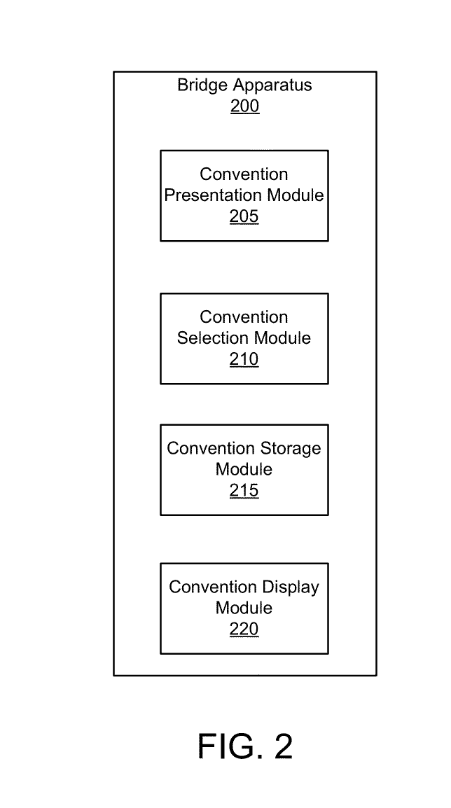

The network 104 may include a global communications network such as the internet, a Local Area Network (“LAN”), multiple LANs communicating over the internet, a wide area network (“WAN”), or any other similar communications network. The network 104 may include hardware such as routers, switches, cabling, and other communication hardware. Each client 106 may be embodied as a portable computer, a handheld computing device, a touch device, a personal desktop assistant (“PDA”), a tablet computer, a mobile phone, a smart phone, and the like. In one embodiment, the client 106 may be a device specifically designed for an embodiment of the invention disclosed herein and may include a bridge apparatus 200, which will be described in more detail below with reference to FIG. 2. In other embodiments, a plurality of clients 106 may be included in the system 100, wherein each client may include a bridge apparatus 200.

In one embodiment, each client 106 may communicate with the server 102 through the network 104. In another embodiment, a client 106 communicates with the server 102 by way of a program executing on the client 106, such as a mobile application configured to access, download, and/or upload data from the server 102. In certain embodiments, the application on the client device 106 may allow a user to interact with the electronic convention card by using an input device, such as a keyboard, a stylus, or the like.

FIG. 2 is a schematic block diagram of one embodiment of a bridge apparatus 200 in accordance with the present subject matter. The bridge apparatus 200, in one embodiment, includes a convention presentation module 205, a convention selection module 210, a convention storage module 215, and a convention display module 220, which are described below.

The convention presentation module 205, in one embodiment, visually presents a list of predefined conventions to a bridge player on an electronic display of an electronic device 106. In one embodiment, the predefined bridge conventions may involve both bidding and playing strategies for a partnership in a contract bridge game. The predefined conventions, in certain embodiments, may include opening bid conventions, fit-seeking conventions, slam-seeking conventions, defensive conventions, counter conventions, and the like.

The convention selection module 210, in one embodiment, may receive a player's selected conventions from the list of predefined bridge conventions presented by the convention presentation module 205. In one embodiment, the player may select the desired bridge convention by interacting with the electronic device 106 using an input device, such as a keyboard, or, in the case of a touch screen enabled electronic device 106, with a stylus, a finger, or the like.

The convention storage module 215, in one embodiment, may store a player's selected conventions on a computer readable storage medium such that the selected conventions may be recalled at a later time. In one embodiment, a player may be assigned a unique identifier, which may be stored with the selected conventions such that the selected conventions are associated with the player. In this manner, a list of conventions that a player has previously selected may be easily recalled from the computer readable storage media and displayed for the player, who may again select a convention that has been previously used.

The convention display module 220, in one embodiment, may display the selected convention on the electronic display in response to a player requesting to view the convention. In another embodiment, the convention display module 220 may display the unique identifiers associated with a player and the player's teammate on the electronic display, along with the selected convention.

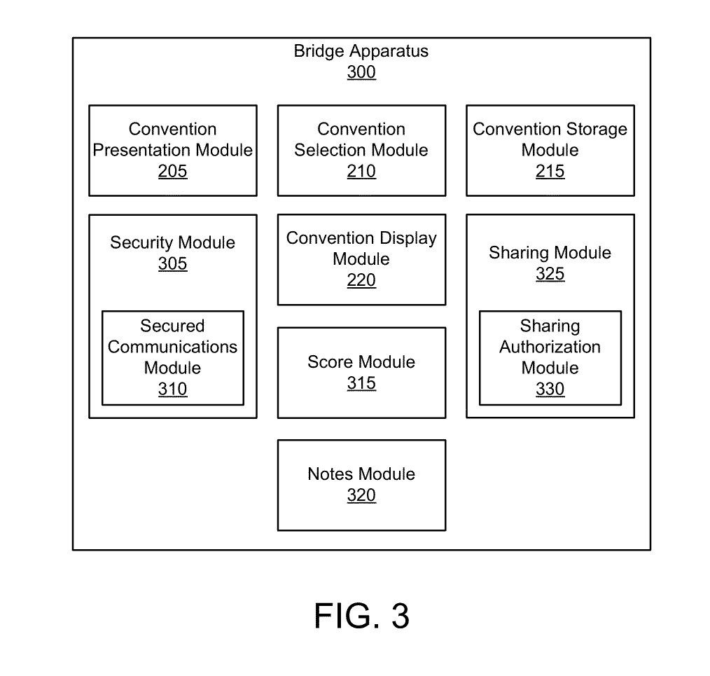

FIG. 3 depicts another embodiment of a bridge apparatus 300. The description of the apparatus 300 refers to elements of FIGS. 1 and 2, like numbers referring to like elements. The depicted apparatus 300 includes a convention presentation module 205, a convention selection module 210, a convention storage module 215, and a convention display module 220, wherein these modules may be substantially similar to the like numbered modules in FIG. 2. Further, the apparatus 300 includes a security module 305, a secured communication module 310, a score module 315, a notes module 320, a sharing module 325, and a sharing authorization module 330, which are described below.

In one embodiment, the electronic device 106 may send and/or receive communications to and/or from another electronic device 106. In another embodiment, the security module 305 may disable the communications capabilities of the electronic device 106. The security module 305, in a further embodiment, may disable the communication capabilities of the electronic device 106 in response to receiving a command to enter a game play mode, such that when the electronic device 106 is in game play mode, it does not send and/or receive communications to and/or from another device. The security module 305, in one embodiment, may re-enable the communication capabilities of the electronic device 106. For example, the security module 305 may re-enable the communication capabilities of the electronic device 106 after exiting game play mode.

In another embodiment, the security module 305, may disable and/or re-enable the communication capabilities of the electronic device 106 through a security protocol. The security protocol, in one embodiment, may include a password and/or a security key. For example, the security protocol may be controlled by an official at a bridge tournament and the official may, using the security module 305, disable and/or re-enable communication capabilities. In other embodiments, the security module 305 may disable and/or re-enable applications running on the electronic device 106. In another embodiment, the security module 305 may disable and/or re-enable access to applications running on the electronic device 106.

In one embodiment, the security module 305 includes a secured communication module 310, which is configured to enable communication with a secured server. In one embodiment, the secured server is substantially similar to the server 102 depicted in FIG. 1. The secured server 102, in another embodiment, may be controlled by the officials of a bridge tournament, such as the World Bridge Federation, the American Contract Bridge League, and the like. In certain embodiments, the secured server 102 may utilize a handshake authentication protocol in order to verify the identity of remote clients 106. The secured server 102, in one embodiment, receives bridge scores from the secured communication module 310 over a secured communication channel, which, in one example, may utilize digital certificates, encryption algorithms, and the like to maintain the integrity of the data being transferred.

In certain embodiments, the secured communication module 310 may restrict communication with the secured server 102 to a one-way communication channel, such that information may either be sent from the secured communication module 310 to the secured server 102 or from the secured server 102 to the secured communication module 310. In another embodiment, the secured communication module 310 enables communication with the electronic device 106 while the security module 305 and/or secured communication module 310 disables communication capabilities of the electronic device 106 with other devices. In another embodiment, the secured communication module 310 enables communication with the electronic device 106 while the security module 305 and/or secured communication module 310 disables communication capabilities of the electronic device 106 with some devices while allowing communication with other devices, such as an electronic device 106 of a player in a particular bridge game, such as a partner's electronic device 106 or a competitor's electronic device 106.

The score module 315, in one embodiment, stores a bridge player's score. In another embodiment, the score module 315 calculates the bridge player's score. In other embodiments, the score module 315 receives the score from a bridge player's input on the electronic device 106. Additionally, the bridge apparatus 300 may include a notes module 320, which, in one embodiment, allows a player to receive, store, and display notes entered by a bridge player. A bridge player, in certain embodiments, may enter notes using a keyboard input or, in other embodiments, a touch input device where the electronic device 106 is touch enabled. Moreover, a bridge player may share and/or receive notes with other bridge players over a secured communication channel. For example, the secured communication module 310 may allow communication outside of play mode but may disable transmitting notes while in play mode. In another embodiment, the secured communication module 310 allows transmitting notes during play mode to selected players, such as a partner or a competitor at a table where a bridge game is in progress. In other embodiments, notes may be stored on the computer readable storage media of the electronic device 106 and displayed on the display of the electronic device 106 in response to a display request from a bridge player.

In one embodiment, the bridge apparatus 300 includes a sharing module 325 that shares player information with an electronic device 106 of another player. The player information may include selected conventions, bridge scores, notes, and the like. In one embodiment, the sharing module 325 enables the sharing of player information with authorized electronic devices 106 through a sharing authorization module 330. The sharing authorization module 330, in one embodiment, may also disable the sharing of player information, such as conventions, bridge scores, notes, and the like, with unauthorized electronic devices 106. In one embodiment, the settings of the sharing authorization module 330 may be accessed by using a secure protocol, such as a password, security key, and/or the like. The sharing module 325 may work in conjunction with the secured communications module 310 to selectively allow communication with the server 102 and/or other electronic devices 106.

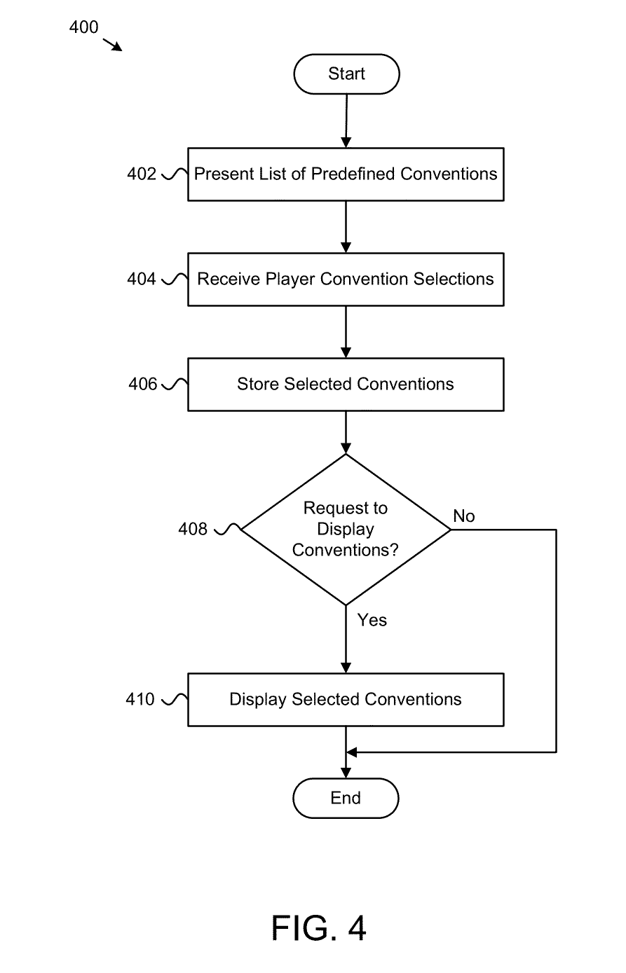

FIG. 4 is a schematic flow chart diagram illustrating one embodiment of a method 400 for using a bridge apparatus. The method 400 begins and the method 400 presents 402 a list of predefined conventions to a player. The list of predefined conventions is presented to the player on an electronic display of an electronic device 106. The predefined conventions include bidding and playing conventions associated with a bridge card game. The method 400 may present 402 the predefined list of conventions using a drop-down menu, a menu with open circles that allows the player to select an item by touching the circle, by filling in a blank, and the like. In one embodiment, the convention presentation module 205 presents the list of predefined conventions to the player.

The method 400 receives 404 one or more convention selections from the player where each selected convention is from the list of predefined conventions. In one embodiment, the convention selection module 210 receives the selected conventions. The player may input the selected conventions to the electronic device 106. In another embodiment, the method 400 receives 404 conventions that are not on the list of predefined conventions. For example, the convention presentation module 205 may display a field for custom conventions. The method 400 stores 406 the selected convention on a computer readable storage media, together with the player's unique identifier. In one embodiment, the convention storage module 215 stores 406 the selected conventions. The convention display module 220, in response to a request 408 to display the selected conventions, may display 410 the selected conventions on the electronic display and the method 400 ends.

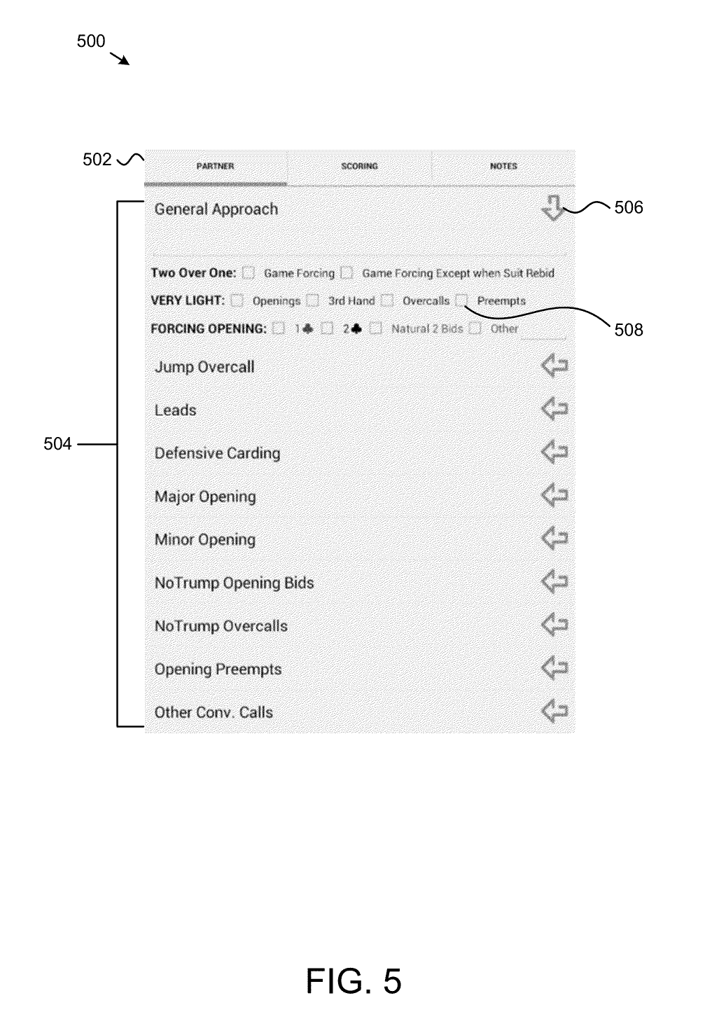

FIG. 5 depicts one example of a convention presentation module 205 visually presenting a list of predefined conventions 504 on an electronic display of an electronic device 106. In one embodiment, a bridge player may request to view the list of predefined conventions 504 by selecting a tab 502, or like interface component, using an input device, such as a stylus, finger, and the like. In another embodiment, the convention presentation module 205 visually presents the list of predefined conventions 504 such that only the titles of the conventions are viewable. In one embodiment, a convention title may be expanded to reveal a list of selectable convention options. For example, a bridge player may touch an arrow 506, or similar object, next to the convention title to expand the convention in the list of predefined conventions 504, which reveals the convention's selectable options. The convention's options, in a further embodiment, may be selected by touching a circle or a box 508, filling in a blank, and the like. In some embodiments, only one convention in the list of predefined conventions 504 may be expanded at a time in order to conserve the viewing area of the electronic display. In another embodiment, more than one convention in the list of predefined conventions 504 may be expanded at one time to display multiple conventions' options.

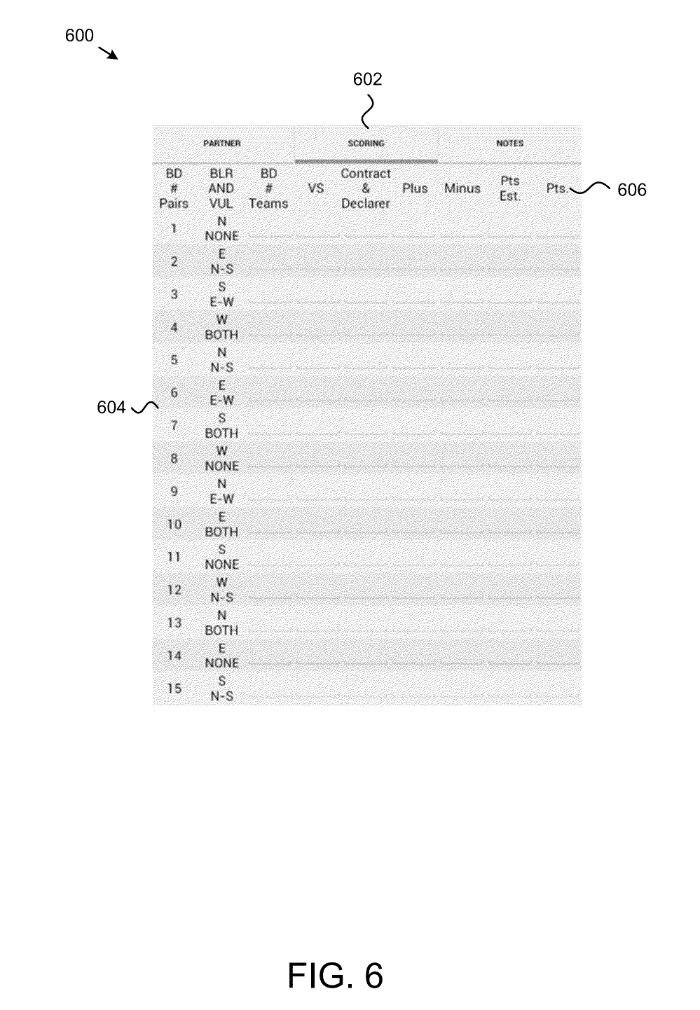

FIG. 6 depicts one example of a scoring table 604, which may be displayed on the electronic display of the electronic device 106 by selecting the scoring tab 602. In one embodiment, the scoring table 604 may be interactive to allow a bridge player to manually enter their scoring information in the various fields 606 on the scoring table 604. As described above, in one embodiment, the score module 315 may calculate a bridge player's score based on the inputted scoring information in the fields 606 of the scoring table 604. For example, a bridge player may enter scoring information such as the point values for slams, overtricks, undertricks, other bonuses, and the like. The score module 315 may then use this information to automatically calculate the bridge player's score. Alternatively, in one embodiment, the automatic score calculation of the score module 315 may be overridden to allow a bridge player to manually enter their bridge scores. In certain embodiments, the fields 606 of the scoring table 604 may change based on the type of scoring system being used during a bridge game.

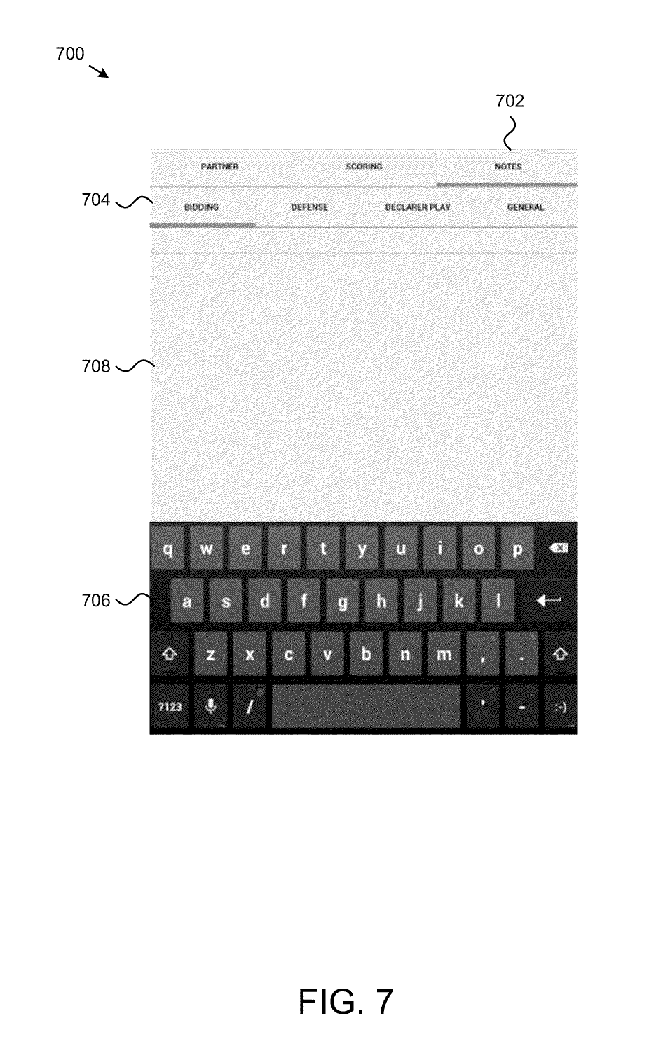

FIG. 7 depicts one example of an interface for entering and displaying notes created by the notes module 320. In one embodiment, selecting the notes tab 702 may display the notes interface on the electronic display of the electronic device 106. In another embodiment, notes may be entered by a player on a virtual keyboard 706 by using an input object such as a stylus, finger, and the like. As a user types on the virtual keyboard 706, in other embodiments, the characters are displayed in the viewing area 708. The virtual keyboard 706, in some embodiments, may be hidden in order to provide more space in the viewing area 708. In certain embodiments, notes may be given a title by a player, a list 704 of which may be displayed along the top of the viewing area. A note may be displayed and/or edited by selecting the title of the note from the list of displayed notes 704. Alternatively, in one embodiment, notes may be grouped by categories (not shown), which may be customizable by the player, and may also be listed along the top of the viewing area 708.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a convention presentation module that presents a list of predefined conventions to a player, the list of predefined conventions presented to the player on an electronic display of an electronic device, the predefined conventions comprising bidding and playing conventions associated with a bridge card game;
a convention selection module that receives one or more convention selections from a player, each selected convention from the list of predefined conventions, the player inputting the selected conventions to the electronic device;
a convention storage module that stores the selected conventions on a computer readable storage media, the selected conventions stored with an identifier associated with the player; and
a convention display module that displays the selected conventions on the electronic display in response to a request by the player to display the conventions.

2. The apparatus of claim 1, wherein the convention display module displays, along with the selected conventions, an identifier associated with the player and an identifier of a teammate of the player.

3. The apparatus of claim 1, further comprising a notes module that receives, stores, and displays notes entered by the player.

4. The apparatus of claim 1, further comprising a score module that stores a score of a bridge game of the player, the score being one or more of calculated and inputted by the player.

5. The apparatus of claim 1, further comprising a security module that disables communication capabilities of the electronic device in response to receiving a command to enter a game play mode.

6. The apparatus of claim 5, wherein the security module further re-enables communication capabilities of the electronic device and wherein the security module disables and re-enables communication capabilities of the electronic device by way of a security protocol, the security protocol comprising one or more of a password and a security key.

7. The apparatus of claim 5, wherein the security module one or more of disables one or more applications running on the electronic device and disables access to one or more applications running on the electronic device.

8. The apparatus of claim 5, wherein the security module further comprises a secured communication module that enables communication with a secured server, wherein scores are communicated to the secured server, the secured server being controlled by officials of a bridge tournament.

9. The apparatus of claim 8, wherein the secured communication module restricts communication to a one-way communication to the secured server.

10. The apparatus of claim 1, wherein the convention storage module stores the selected conventions along with an identifier associated with the player.

11. The apparatus of claim 1, further comprising a sharing module that shares, with an electronic device of another player, one or more of selected conventions of a player, a bridge score, and notes.

12. The apparatus of claim 11, wherein the sharing module further comprises a sharing authorization module that enables the sharing module to share selected conventions, scores, and notes with authorized electronic devices and disables sharing of the selected conventions, scores, and notes of unauthorized electronic devices, the sharing authorization module being accessed using a password.

13. A method comprising:
presenting a list of predefined conventions to a player, the list of predefined conventions presented to the player on an electronic display of an electronic device, the predefined conventions comprising bidding and playing conventions associated with a bridge card game;
receiving one or more convention selections from a player, each selected convention from the list of predefined conventions, the player inputting the selected conventions to the electronic device;
storing the selected conventions on a computer readable storage media, the selected conventions stored with an identifier associated with the player; and
displaying the selected conventions on the electronic display in response to a request by the player to display the conventions.

14. The method of claim 13, further comprising displaying, along with the selected conventions, an identifier associated with the player and an identifier of a teammate of the player.

15. The method of claim 13, further comprising storing a score of a bridge game of the player, the score being one or more of calculated and inputted by the player.

16. The method of claim 13, further comprising disabling communication capabilities of the electronic device in response to receiving a command to enter a game play mode.

17. The method of claim 13, further comprising disabling one or more applications running on the electronic device and disables access to the one or more applications running on the electronic device.

18. The method of claim 13, further comprising enabling communication with a secured server, wherein scores are communicated to the secured server, the secured server being controlled by officials of a bridge tournament.

19. The method of claim 13, further comprising sharing, with an electronic device of another player, one or more of selected conventions of a player, a bridge score, and notes.

20. A system comprising:
an electronic device comprising an electronic display;
a convention presentation module that presents a list of predefined conventions to a player, the list of predefined conventions presented to the player on the electronic display, the predefined conventions comprising bidding and playing conventions associated with a bridge card game;
a convention selection module that receives one or more convention selections from a player, each selected convention from the list of predefined conventions, the player inputting the selected conventions to the electronic device;
a convention storage module that stores the selected conventions on a computer readable storage media, the selected conventions stored with an identifier associated with the player; and
a convention display module that displays the selected conventions on the electronic display in response to a request by the player to display the conventions.
